(19) United States
(12) Patent Application Publication
(10) Pub. No.: US 2021/0364876 A1
(43) Pub. Date: Nov. 25, 2021

(54) PIXEL STRUCTURE AND DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Zhijuan Long, Shenzhen (CN)

(21) Appl. No.: 16/624,923

(22) PCT Filed: Dec. 11, 2019
(86) PCT No.: PCT/CN2019/124605

§ 371 Date: Dec. 20, 2019

(30) Foreign Application Priority Data
Sep. 6, 2019 (CN) 201910841663.9

(51) Int. Cl. G02F 1/1362

(52) U.S. Cl. CPC G02F 1/136286

(57) ABSTRACT

A pixel structure and a display panel are provided. The pixel structure includes a plurality of pixel units arranged in an array. Three of the pixel units form a pixel group coupled to a data line and two scan lines arranged in sequence. The pixel structure includes a first pixel unit coupled between a first scan line and the data line, a second pixel unit coupled between a second scan line and the data line, and a third pixel unit coupled between one scan line that is different from an interval configuration and the data line.

### FIELD OF DISCLOSURE

The present application relates to the field of displays, and in particular, to a pixel structure and a display panel.

### BACKGROUND

Liquid crystal displays (LCDs) have been widely used recently. With an improvement of driving technologies, they have advantages of low power consumption, low weight, low voltage driving, etc., and have been widely used in camcorders, notebook computers, desktop monitors, and various projection equipment.

A liquid crystal display panel usually has a gate driving circuit, a source driving circuit, and a pixel array. There are a plurality of pixel circuits in the pixel array. Each pixel circuit is turned on and off according to a scan signal provided by the gate driving circuit, and displays a data image according to a data signal provided by the source driving circuit.

A data line sharing (DLS) refers to a use of different scan lines for addressing by sharing a data line between two adjacent sub-pixels, so as to reduce the data line in half. However, a red pixel, a green pixel, and a blue pixel of a DLS column inversion architecture are controlled by scan line (gate) arranged in odd line and even line, so a half pixel of the red pixel, the green pixel, and the blue pixel will generate a secondary charge feedthrough, thereby affecting a common electrode (vcom) and IS of the panel.

As shown in FIG. 1, a first red pixel 10 and a second red pixel 20 are turned on by a scan line 1 (gate 1) and a scan line 2 (gate 2), respectively. The first red pixel 10 and a scan line 1 (gate 1) of a current stage generate a first pixel capacitor 11 (Cgs). The first red pixel 10 and a scan line 2 (gate 2) of a next stage generate a second pixel capacitor 12 (Cgs 2). The second red pixel 20 and the scan line 2 (gate2) of the current stage generate the first pixel capacitor 11 (Cgs). Therefore, the first red pixel 10 does one more charge feedthrough than the second red pixel 20.

### SUMMARY OF DISCLOSURE

The present disclosure proposes a new pixel structure. By changing a connection method, a secondary charge feedthrough of the red pixel and the green pixel is avoided, which can effectively improve IS.

In order to solve the above technical problems, an object of the present disclosure is to provide a pixel structure including a plurality of pixel units arranged in an array. Three of the pixel units form a pixel group coupled to a data line and two scan lines arranged in sequence. The pixel structure includes a first pixel unit coupled between a first scan line and the data line, a second pixel unit coupled between a second scan line and the data line, and a third pixel unit coupled between one scan line that is different from an interval configuration and the data line.

In one embodiment of the present disclosure, the first pixel unit and the second pixel unit are arranged in parallel and are alternatively arranged.

In one embodiment of the present disclosure, the second pixel unit and the third pixel unit are arranged in parallel and are alternatively arranged.

In one embodiment of the present disclosure, the first pixel unit and the third pixel unit are arranged in parallel and are alternatively arranged.

In one embodiment of the present disclosure, in the two scan lines, the first scan line is a (2n−1)th scan line, and the second scan line is a (2n)th scan line, where n is a positive number.

In one embodiment of the present disclosure, the first pixel unit is a red pixel.

In one embodiment of the present disclosure, the second pixel unit is a green pixel.

In one embodiment of the present disclosure, the third pixel unit is a blue pixel.

In one embodiment of the present disclosure, the blue pixel has the lowest brightness.

Another object of the present disclosure is to provide a display panel, including a substrate and a pixel structure. The pixel structure includes a plurality of pixel units arranged in an array. Three of the pixel units form a pixel group coupled to a data line and two scan lines arranged in sequence. The pixel structure includes a first pixel unit coupled between a first scan line and the data line, a second pixel unit coupled between a second scan line and the data line, and a third pixel unit coupled between one scan line that is different from an interval configuration and the data line.

The present disclosure proposes a new pixel structure. By changing a connection method, a secondary charge feedthrough of the red pixel and the green pixel is avoided, which can effectively improve IS.

### BRIEF DESCRIPTION OF DRAWINGS

In order to illustrate the technical solutions in the embodiments of the present disclosure or in the prior art more clearly, the following briefly introduces the accompanying drawings required for describing the embodiments or the prior art. The accompanying drawings in the following description are merely some embodiments of the present disclosure, and persons of ordinary skill in the art may still derive other drawings from these accompanying drawings without creative effort.

FIG. 1 is a schematic diagram of a pixel structure in the prior art.

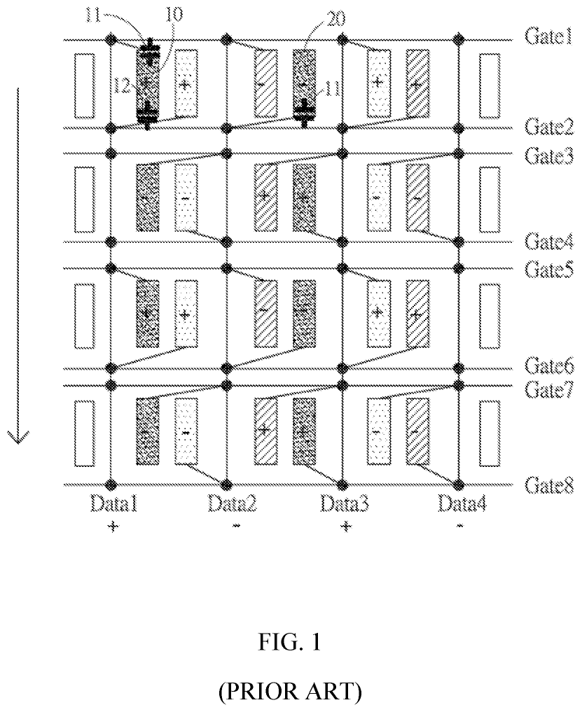

FIG. 2 is a schematic diagram of a pixel structure according to an embodiment of the present disclosure.

### DETAILED DESCRIPTION

Please refer to drawings, the same reference numerals denote units with similar structures. The following description is based on the exemplified specific embodiments of the present disclosure, which should not be construed as limiting other specific embodiments that are not detailed here.

The following descriptions for the respective embodiments are specific embodiments capable of being implemented for illustrations of the present disclosure with referring to appended figures. In the descriptions of the present disclosure, spatially relative terms, such as “upper”, “lower”, “front”, “back”, “left”, “right”, “inner”, “outer”, “lateral”, and the like, may be used herein for ease of description as illustrated in the figures. Therefore, it will be understood that the spatially relative terms are intended to illustrate for understanding the present disclosure, but not to limit the present disclosure.

In the drawings, the thickness of layers, films, panels, regions, etc., are exaggerated for clarity. In the drawings, for understanding and ease of description, the thicknesses of some layers and areas are exaggerated. It will be understood that, when an element such as a layer, film, region, or substrate is referred to as being “on” another element, it can be directly on the other element or intervening elements may also be present.

The drawings and description are to be regarded as illustrative in nature and not restrictive. Like reference numerals designate like elements throughout the specification. In addition, the size and thickness of each component shown in the drawings are arbitrarily shown for understanding and ease of description, but the present disclosure is not limited thereto.

In addition, in the specification, unless explicitly described to the contrary, the word “comprise” and variations such as “comprises” or “comprising” will be understood to imply the inclusion of stated elements but not the exclusion of any other elements. Furthermore, in the specification, “on” implies being positioned above or below a target element and does not imply being necessarily positioned on the top on the basis of a gravity direction.

In order to further explain the technical means and effects adopted by the present disclosure to achieve the intended purpose of the disclosure, a pixel structure and a display panel based on the present disclosure are described below in conjunction with the drawings and specific embodiments. The structure, characteristics, and effects are described in detail later.

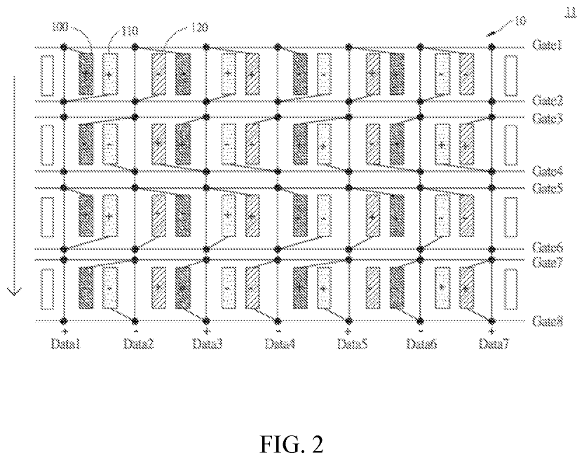

FIG. 2 is a schematic diagram of a pixel structure according to an embodiment of the present disclosure. Please refer to FIG. 2, in the embodiment of the present disclosure, a pixel structure 10 includes a plurality of pixel units 100, 110, 120 arranged in an array. Three of the pixel units 100, 110, 120 form a pixel group coupled to a data line and two scan lines G1, G2 arranged in sequence. The pixel structure includes a first pixel unit 100, a second pixel unit110, and a third pixel unit 120. The first pixel unit is coupled between a first scan line G1 and the data line. The second pixel unit 110 is coupled between a second scan line G2 and the data line. The third pixel unit 120 is coupled between one scan line G1, G2 that is different from an interval configuration and the data line.

In one embodiment of the present disclosure, the first pixel unit 100 and the second pixel unit 110 are arranged in parallel and are alternatively arranged.

In one embodiment of the present disclosure, the second pixel unit 110 and the third pixel unit 120 are arranged in parallel and are alternatively arranged.

In one embodiment of the present disclosure, the first pixel unit 100 and the third pixel unit 120 are arranged in parallel and are alternatively arranged.

In one embodiment of the present disclosure, in the two scan lines G1, G2, the first scan line G1 is a (2n−1)th scan line, and the second scan line G2 is a (2n)th scan line, where n is a positive number.

In one embodiment of the present disclosure, the first pixel unit 100 is a red pixel.

In one embodiment of the present disclosure, the second pixel unit 110 is a green pixel.

In one embodiment of the present disclosure, the third pixel unit 120 is a blue pixel.

In one embodiment of the present disclosure, the blue pixel has the lowest brightness.

In one embodiment of the present disclosure, a display panel includes a substrate (not shown) and a pixel structure 10. The pixel structure 10 includes a plurality of pixel units 100, 110, 120 arranged in an array. Three of the pixel units 100, 110, 120 form a pixel group coupled to a data line and two scan lines G1, G2 arranged in sequence. The pixel structure includes a first pixel unit 100 coupled between a first scan line G1 and the data line, a second pixel unit 110 coupled between a second scan line G2 and the data line, and a third pixel unit 120 coupled between one scan line G1, G2 that is different from an interval configuration and the data line.

Please refer to FIG. 2, in the embodiment of the present disclosure, under a driving mode of maintaining a data line sharing architecture column inversion, the red pixel 100 in the same row is turned on by the gate scan line G1 of the same stage and the green pixel 110 is turned on by the gate scan line G2 of the same stage. At the same time, the red pixel 100 and the green pixel 110 have the same number of charge feedthrough. The blue pixel 120 in the same row is still turned on by one gate scan lines G1, G2 of a different stage, but a brightness of the blue pixel 120 is the lowest, so a risk caused by the secondary charge feedthrough can be effectively reduced.

The present disclosure proposes a new pixel structure. By changing a connection method, a secondary charge feedthrough of the red pixel and the green pixel is avoided, which can effectively improve IS.

For a person of ordinary skill in the art, various other corresponding changes and modifications can be made according to the technical solution and technical concept of the present disclosure, and all these changes and modifications should fall within the protection scope of the claims appended to the present disclosure.

The subject of the present disclosure can be manufactured and used in industry with industrial applicability.

What is claimed is:

1. A pixel structure, comprising a plurality of pixel units arranged in an array, wherein three of the pixel units form a pixel group coupled to a data line and two scan lines arranged in sequence, wherein the pixel structure comprises:
a first pixel unit coupled between a first scan line and the data line;
a second pixel unit coupled between a second scan line and the data line; and
a third pixel unit coupled between one scan line that is different from an interval configuration and the data line.

2. The pixel structure as claimed in claim 1, wherein the first pixel unit and the second pixel unit are arranged in parallel and are alternatively arranged.

3. The pixel structure as claimed in claim 1, wherein the second pixel unit and the third pixel unit are arranged in parallel and are alternatively arranged.

4. The pixel structure as claimed in claim 1, wherein the first pixel unit and the third pixel unit are arranged in parallel and are alternatively arranged.

5. The pixel structure as claimed in claim 1, wherein in the two scan lines, the first scan line is a (2n−1)th scan line, and the second scan line is a (2n)th scan line, where n is a positive number.

6. The pixel structure as claimed in claim 1, wherein the first pixel unit is a red pixel.

7. The pixel structure as claimed in claim 1, wherein the second pixel unit is a green pixel.

8. The pixel structure as claimed in claim 1, wherein the third pixel unit is a blue pixel.

9. The pixel structure as claimed in claim 8, wherein the blue pixel has the lowest brightness.

10. A display panel, comprising:
a substrate; and
a pixel structure comprising a plurality of pixel units arranged in an array, wherein three of the pixel units form a pixel group coupled to a data line and two scan lines arranged in sequence, wherein the pixel structure comprises:
a first pixel unit coupled between a first scan line and the data line;
a second pixel unit coupled between a second scan line and the data line; and
a third pixel unit coupled between one scan line that is different from an interval configuration and the data line.
